(19) United States
(12) Patent Application Publication
(10) Pub. No.: US 2022/0269028 A1
(43) Pub. Date: Aug. 25, 2022

(54) Optical Fiber Protective Composite Coating

(71) Applicant: Mehdi Ravanbakhsh, Tehran (IR)

(72) Inventor: Mehdi Ravanbakhsh, Tehran (IR)

(21) Appl. No.: 17/627,443

(22) PCT Filed: Jul. 23, 2020
(86) PCT No.: PCT/IR2020/050023

§ 371 Date: Jan. 14, 2022

(30) Foreign Application Priority Data
Jul. 27, 2019 (IR) 13985014000300362

(51) Int. Cl. G02B 6/44

(52) U.S. Cl. CPC G02B 6/4486; G02B 6/4432; G02B 6/4404

(57) ABSTRACT

In this innovation, contrary to the usual method used in the production of Tight Buffer and Loose Tube cables, instead of covering the optical fibers one by one with, 1 to 8 optical fibers core located on the cross section of a ROD that made of composite of fiber reinforced polymers) FRP) and produce in pultrusion process. Each of these FRP rods which the optical fibers are embedded in is called an Optical Composite Unit (OCU). Each OCU is coated with a layer of plastic. When it is necessary to make the optical fiber available for connection (fusion) operation, by separating the reinforce fiber, the FRP structure is broken and the optical fibers are made available for strip and fusion.

The use of optical fiber protective composite coating increase strength and efficiency of the fiber optic cable greatly and greatly reduces the cost of production and execution.

In this invitation we use unusual material for optical fiber core protection to create better optical cable.

### TECHNICAL FIELD

Each fiber optic cable consists of a number of optical fibers (Optical Fiber Core) which is covered in the last layer with a protective coating of acrylic or colored silicone (coating) so that the diameter of each fiber reaches 200 to 250 microns. In the next step, several protective coating layers is placed in such a way as to protect the optical fibers from physical effects (mechanical, temperature and humidity). (FIG. 1)

There have been two major categories of fiber optic shielding so far:

1. In the first type, which is called Loose-Tube, 1 to 24 optical fibers with anti-moisture and anti-freeze gel are placed in a plastic tube (PBT, Polyamide, PVC), which these tubes are called Loose-Tube. 1 to 12 Loose-Tube with other physical strengthening elements such as Aramid Yarn to increase the tensile strength of the cable, non-metallic composite element (FRP) to strengthen the elastic state of the cable and increase the tensile strength of the cable with components Other protectors such as water blocking yarn to prevent water from spreading in the cable in one or more plastic sheaths (PVC, Polyamide, Polyurethane, Polyethylene) or in some layers covered with metal sheaths to protected fiber optic against mechanical and temperature and humidity effects of the environment used. (FIG. 2)

2. In the second type, which is called Tight-Buffer, each of the optical fibers is covered separately with a layer of plastic (PVC, Polyamide, Polyurethane, Polyethylene) with a thickness of approximately 325 microns, which is called Tight-Buffer coating. In the next step, 1 to 24 strands of Tight-Buffer coating are not categorized or categorized in batches of 1 to 24 with other physical strengthening elements such as aramid fibers to increase the tensile strength of the cable. Non-metallic intermediate (composite) (FRP) to strengthen the elastic state of the cable and increase the tensile strength of the cable along with other protective components such as water blocking yarn to prevent water from spreading in the cable in one or more sheaths Made of plastic (PVC, Polyamide, Polyurethane, Polyethylene) or in some layers in a cover of metal sheaths to protect the fiber optic fiber against the mechanical and temperature effects of the environment used. (FIG. 3)

Using different elements in different parts of the cable, each of which has a separate role, such as aramid fibers, FRP as central strength member, moisture-proof tape, independent protective covers for each optical fiber in various types of Tight-Buffer cables and protective tube with antifreeze gel in all types of Loose-Tube cables and due to the fact that these components do not fit perfectly together with geometric shapes, eventually the diameter of the final cable increases according to the required mechanical and temperature resistance and this increase in diameter is also effective on the following factors:

1. Decreased optical fiber density relative to cable cross section.
2. Cable costs will increase due to the use of different elements as well as due to the increase in processes step related to cable production.
3. Increase the cost of transportation and maintenance during storage and during the installation of cable.
4. Costs related to executive operations also increase according to the following parameters:
4.1. The cost of goods related to cable installation is greatly increased in executive projects for the installation of optical cables such as ducts and micro ducts.
4.2. Costs related to ground drilling, overwork and rehabilitation of drilled land increase due to the increase in duct diameter.
4.3. The cost of municipal fines increases with increasing drilling width.
4.4. Increasing the weight and volume of the cable as well as increasing the volume of excavation drastically reduces the speed of the operation.
5. Due to the increase in the weight of the unit length and also the increase in the diameter of the cable, there is a great limitation regarding the number and capacity of aerial cables that can be installed on the transmission and lighting beams.

### BACKGROUND ART

Due to the mentioned problems regarding the low number of optical fibers in optical cables in relation to the high diameter of the cable, a new subset of Tight-Buffer cables called ribbon cables was developed.

In Tight-Buffer cables, each fiber was covered separately with a polymer (plastic) coating as a separate optical fiber, but in Ribbon cables, 4 to 12 strands of optical fiber that are glued together horizontally (strip) are covered with a polymer coating. (FIG. 4) (FIG. 5)

ribbon cables design has reduced the cross-sectional area of optical cables to a very limited extent, but this design has faced the following limitations and shortcomings:

1. Due to the limited and predetermined shape of each ribbon, in practice in single-strip cables, the geometric shape of the cable cross section is not circle, and this deformation prevents the use of this cable in ducts or aerial installation. if the shape of the cross-section of the cable change to circle large space of the cable remains unused.

2. Almost all the previous elements of Tight-Buffer cables such as plastic sheath, FRP, aramid fibers and moisture-proof tape are also present in Ribbon cables, which eventually lead to an increase in cable diameter, price and weight.

3. Ribbon cables are economical only when they need very high capacities of optical fiber and their cost is not economical in low capacity cables.

### SUMMARY OF INVENTION

In this innovation, contrary to the usual method used in the production of Tight-Buffer cables, instead of covering the optical fibers one by one with plastics, 1 to 8 optical fibers With colored acrylic or colored silicone coating or any other protective coating (or without protective coating) Regularly located on the cross section or outer surface of a ROD (or any other geometric or non-geometric shape) that made of composite of fiber reinforced polymers FRP (Fiber Reinforcement Plastic or polymer) be produced in a Pultrusion process. FRP ROD diameter can be 300 microns (or less) to 1200 microns (or more). Optical fibers are placed at the FRP cross-section in such a way that their position can be constant or variable in length and change their position regularly or irregularly at certain distances. In this case, all or part of the cross section of the optical fiber placed in the cross section of FRP ROD. Each of these FRP rods which the optical fibers are embedded in is called an optical composite unit (OCU). Each optical composite unit is coated with a layer by thickness of 50 microns to 300 microns of plastic and in some cases the optical composite unit can be uncoated. One to any number of optical composite units can be placed next to each other with any arrangement and form an optical cable with different capacities. Dimensions and cross-sectional shape of each optical composite unit can be designed and created in any geometric or non-geometric shape and in any dimensions so that there is at least empty space between the optical composite units in cable. The location and the number of the optical Fiber in the optical composite unit can be changed according to the application of the optical cable and special mechanical resistance parameters.

When it is necessary to make the optical fiber available for connection (fusion) operation, by separating the reinforce fiber, the FRP structure is broken and the optical fibers are made available for strip and fusion. (FIG. 6).

Structural Components of Each Composite Unit: (FIG. 6).

1. Plastic outer cover (PVC, Polyamide, Polyurethane, Polyethylene).

2. FRP composite. (Fiber Reinforcement Plastic).

3. Optical fiber with colored acrylic coating with a diameter of 200 to 250 microns.

FRP Composite Consists of Two Main Components: (FIG. 7).

1. Fibers: which typically include continuous fibers of glass, aramid, basalt, carbon, nylon, or natural fibers such as knauf.

2. Resin: which combines with the fibers in a liquid form and deforms into a solid in a chemical process, eventually leading to the integration and bonding of the fibers.

FRP Production Process that Use for this Innovation is Pultrusion: (FIG. 8)

In this innovation, to create optical cables with more capacities, 1 to 24 (or more) of composite units are placed next to each other without the need for other physical reinforcing elements that are normally used in optical cables and finally covered with plastic or metal sheath. (FIG. 9).

Structural components of each Optical Cable: (FIG. 10).

1. Outer cover made of polyamide or polyethylene.

2. Optical composite unit consists of 6 optical fibers.

3. FRP inside each composite unit.

4. Optical fiber embedded in the composite unit.

### Technical Problem

Problems observed in fiber optic cables that are normally produced so far:

1. low fiber optical core density to cable cross section ratio especially in low capacity cable for 1 to 8 cores.

2. high cable cross section and high cable weight when we need the high mechanical performance for cable.

3. high cost multi-stage and intensive production process.

4. The high cost of installation based on the size of cable diameter.

5. The high cost of installation based on the weight and high volume of the cable.

6. Use of various materials and components in cable, which is produced as a result of complexity and increasing the cross-sectional area.

### Solution to Problem

The following ideas have been used to solve the problems and limitations mentioned in fiber optic cables that have been produced so far with common methods and materials:

1. Using a type of raw material that simultaneously protects the optical fiber and creates a suitable mechanical strength for the cable.

2. Use composite materials instead of the usual plastics that have low weight and very high mechanical strength.

3. Location and geometric dimensions of different parts of the cable should be such that there is at least unusable space between the components of the cable.

4. The production process should be simple so that the cable is fully produced in one stage of production.

### Advantageous Effects of Invention

1. Due to the fact that in comparison with conventional Tight-Buffer cables as well as Loose-Tube cables, more optical fibers are placed in the same cross section, in practice, the density of optical fibers in the cross section of the cable has increased significantly. It reduces the diameter of optical cables while maintaining a large capacity, which will reduce the cost of running optical cable installation projects many times over.

2. Due to the fact that a very high percentage of the cable cross-section is FRP, and due to the very high physical properties of FRP, which in some cases is higher than metals, compared to other plastics used in Tight-Buffer and cables loose-tube, This new coating practically provides much higher protection for the optical fiber and greatly increases the parameters of mechanical strength, temperature resistance and moisture resistance of the optical cable, such as the following:

2.1. More resistance to pressure shocks (Impact) to the cable cross section due to the use of FRP instead PBT loose tube used in Loose-Tube cables and PVC fiber optic covers in Tight-Buffer cables. (FIG. 11).

2.2. More tensile strength Due to the very high tensile strength of FRP (close to 1000 to 1500 MPa) in comparison with other plastics used in conventional cables and due to the fact that a very high amount of cross section of this new cable is FRP the tensile strength of the cable is very high. (FIG. 12).

2.3. More resistance to corrosive shocks (Crush Resistance). Surface hardness (shore D Barcol 935) and very high elastic modulus of FRP (about 50 GB) make this possible. (FIG. 13).

2.4. More resistance to successive bends (Repeated bending). The very high modulus of elasticity of FRP (about 50 GB young modulus) makes this possible. (FIG. 14).

2.5. More resistance to cable torsion. Due to the high flexibility of FRP (flexibility module close to 50 GPA) this is possible. (FIG. 15).

2.6. Reduce the allowable radius of curvature of the cable (Cable bend). Due to the reduction of cable diameter, the radius of curvature is practically reduced compared to cables with the same capacity with the same physical capabilities, which has a very positive effect on the transportation and quality of optical cable installation operations. (FIG. 16).

2.7. Radius the minimum loop diameter at the onset of the kinking of an optical fiber cable Due to the high flexibility of FRP (flexibility module close to 50 GPA) this is possible. (FIG. 17).

2.8. Increasing the resistance range of the cable to high and low temperature changes. Due to the fully adhesive FRP coating, the optical fiber is protected by FRP in flexural and tensile stresses and does not break or change its physical state in the amplitude of temperature changes. (FIG. 18).

3. Very high elasticity modulus of cable. Due to the fact that a large amount of cable cross-section is made of FRP, the product has a very high elasticity, which has the following effects: (FIG. 19).

3.1. prevents the cable from bending and exceeding the minimum allowable radius of curvature of the fiber core.

3.2. prevents the cable from being tied when opening the coil.

3. 3. prevents the cable from twisting when opening the coil.

3. 4. Ability to rearrange and rewind without damaging the cable during installation and operation of the cable.

4. Increase range of air blowing Fiber cable in long-distance in a ground and aerial micro-duct. Due to the fact that a large amount of cross section of each composite unit is made of FRP and due to the fact that the total cross section of the cable is filled by one or more composite units, FRP occupies a very large percentage of the total cross section of the cable. So, due to the very high elasticity of FRP, the cable produced by this method will have a very high elasticity, which will greatly increase the possibility of cable creep in the duct and micro-duct.

5. Reduction of cable diameter due to the removal of elements that were used in conventional cables to increase physical strength or increase resistance to water penetration, and in this type of cable due to the use of composite units no longer need to use them. Including these elements:

6. No need to use composite non-metallic intermediate element (FRP) to provide the elastic properties of the cable and increase the tensile strength of the cable. Due to the fact that the wire covering units themselves are made of FRP, in practice, the elasticity and tensile strength of the cable have been provided to a much greater extent than usual standards.

6. 1. No need to use moisture-proof tape. Due to the coverage of optical fibers by FRP and due to the fact that FRP alone is impermeable to water, it will no longer needed to use waterproof tape in cable.

6. 2. No need for aramid fibers in cable. Due to the high percentage of FRP in the cable, the tensile strength of the cable is practically provided by FRP completely and even more than the standard ceiling, and it is no longer necessary to add aramid fibers to increase the tensile strength of the cable.

7. Reduce the cost of producing fiber optic cable for the following reasons:

7. 1. Reduction of raw materials consumption due to physical reduction of cable cross-section, which reduces the consumption of cable materials.

7. 2. Removal of many elements that are present in conventional cables and have been removed in this new type of cable, such as aramid fibers, composite intermediate element, moisture-proof tape and the like.

7. 3. Reduce the number of production processes. Due to the simplification and reduction of cable elements, the number of production processes in making a complete cable is reduced to a quarter to one-eighth compared to conventional cables.

8. Due to the fact that normally the main constituents of FRP and fiber optics are silicon fibers (glass fibers), the combination of FRP and fiber optics has a very similar homogeneity and physical composition. As a result of this integration, the force due to compression, bending and tension is spread evenly over the cross-sectional area and length of the cable and reducing its point effect to a minimum and ultimately leading to a lack of stress concentration at one point. So, force be distributed at all levels of each optical composite unit. This property will eventually lead to a very high increase in cable physical endurance.

9. Very significant reduction in the cost of optical cable installation operations:

9. 1. Due to the huge reduction in cable diameter and the consequent reduction in the diameter and dimensions of ground ducts used for cabling, the cost of cable and duct transportation, drilling costs and repair and reconstruction of drilled routes will be greatly reduced.

9. 2. Reducing the diameter and reducing the number of elements in the cable, which drastically reduces the weight per length unit of cable, greatly increases the capacity of aerial ducts, which have high weight limits.

9. 3. Increasing the cable blowing over much longer distances than conventional cables in aerial and ground ducts greatly reduces network development and maintenance costs.

9. 4. Reducing the diameter of cable will ultimately reduce the diameter of ground ducts, greatly reducing the cost of drilling-related offenses against municipalities.

9. 5. Reducing the volume of drilling, reducing the weight of cables and ducts, reducing the volume and space of drilling and transportation equipment and reducing the number of staff members of the executive group, and this will lead to the ability to perform optical cable installation on busy roads and narrow passages.

### BRIEF DESCRIPTION OF DRAWINGS

All of this picture is about the structure of material that use in regular optical cable and the new invention optical cable.

FIG. 1 Optical Fiber Core components, structure, layer and material.

FIG. 2 Loose Tube optical cable components, structure, layer and material.

FIG. 3 Tight Buffer optical cable components, structure, layer and material.

FIG. 4 Ribbon optical cable components, structure and material.

FIG. 5 Ribbon optical cable structure, layer.

FIG. 6 Composite optical unit (COU) components, structure, layer and material.

FIG. 7 Fiber Reinforcement Plastic (FRP) components, structure and material.

FIG. 8 FRP production process diagram for continuous fiber that named pultrusion.

FIG. 9 Fiber Optical Cable that produce with optical composite unit (OCU).

FIG. 10 Fiber Optical Cable that produce with optical composite unit (OCU).

FIG. 11 Impact test for optical cable.

FIG. 12 Tensile test for optical cable.

FIG. 13 Crush resistance for optical cable.

FIG. 14 Repeated bending test for optical cable.

FIG. 15 Torsion test for optical cable.

FIG. 16 Cable bend test for optical cable.

FIG. 17 Kink test for optical cable.

FIG. 18 Temperature test for optical cable.

FIG. 19 High elasticity modulus of FRP.

FIG. 20 OCU with one optical fiber and without plastic coating.

FIG. 21 OCU with one optical fiber and without plastic coating.

FIG. 22 OCU with one optical fiber and without plastic coating.

FIG. 23 OCU with one optical fiber and with polyamide coating.

FIG. 24 OCU with one optical fiber and with polyamide coating.

FIG. 25 OCU with one optical fiber and with polyamide coating.

FIG. 26 OCU with one optical fiber and with polyamide coating.

FIG. 27 OCU with one optical fiber and with polyamide coating.

FIG. 28 OCU with two optical fiber and without coating.

FIG. 29 OCU with two optical fiber and without coating.

FIG. 30 OCU with two optical fiber and without coating.

FIG. 31 OCU with two optical fiber and without coating.

FIG. 32 OCU with four optical fiber and without coating.

FIG. 33 OCU with four optical fiber and without coating.

FIG. 34 OCU with four optical fiber and without coating.

FIG. 35 OCU with four optical fiber and without coating.

FIG. 36 OCU with four optical fiber and without coating.

FIG. 37 OCU with four optical fiber and without coating.

FIG. 38 OCU with four optical fiber and without coating.

FIG. 39 OCU with two optical fiber and with polyamide coating.

FIG. 40 OCU with two optical fiber and with polyamide coating.

FIG. 41 OCU with two optical fiber and with polyamide coating.

FIG. 42 OCU with two optical fiber and with polyamide coating.

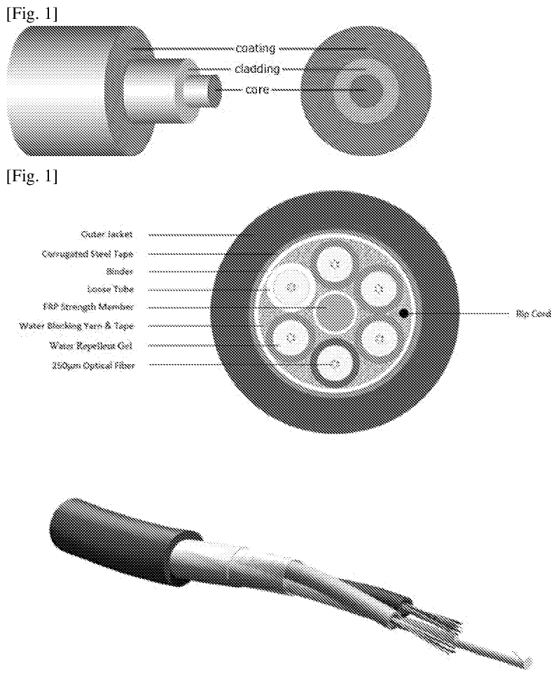

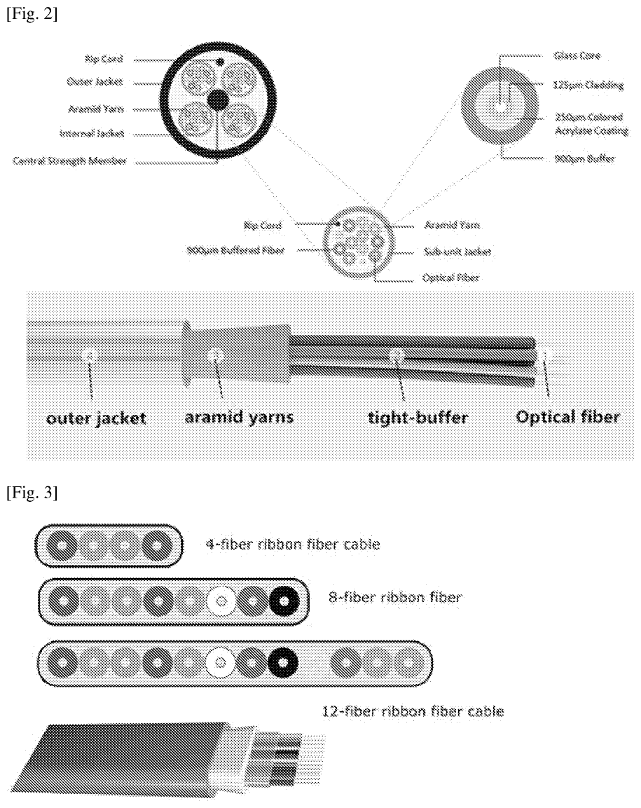

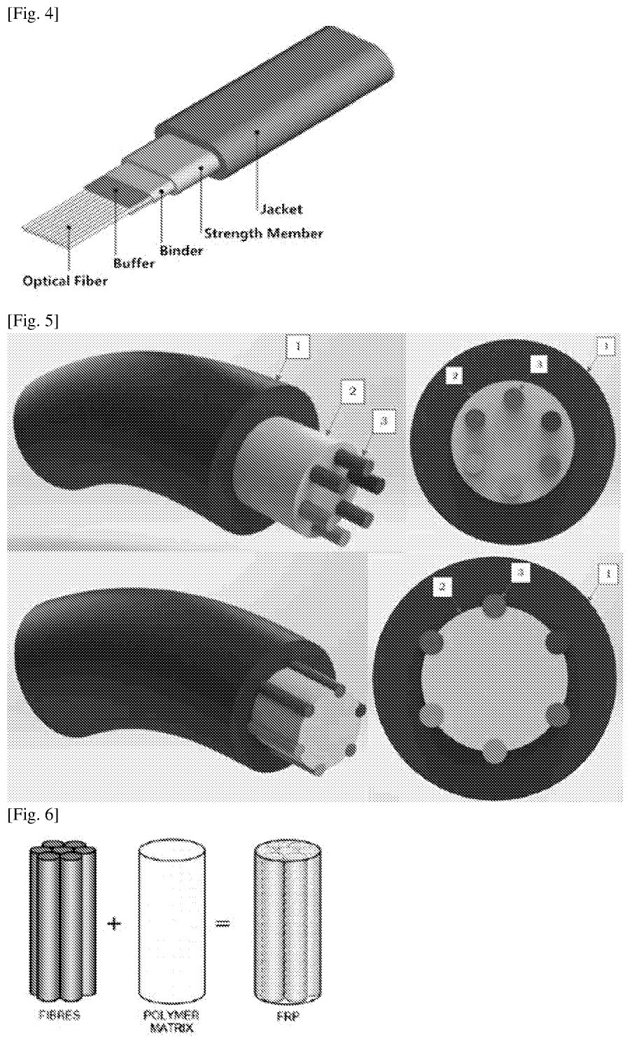

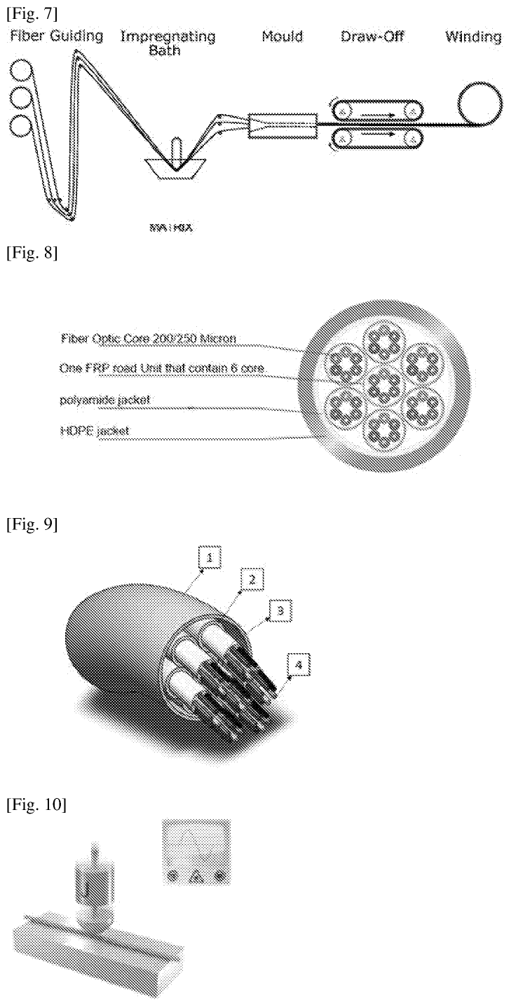

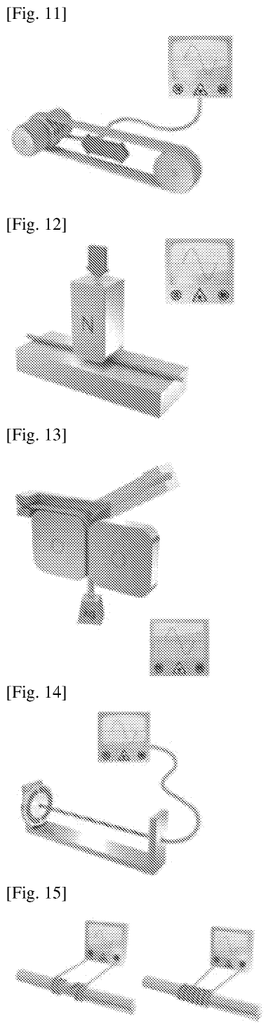

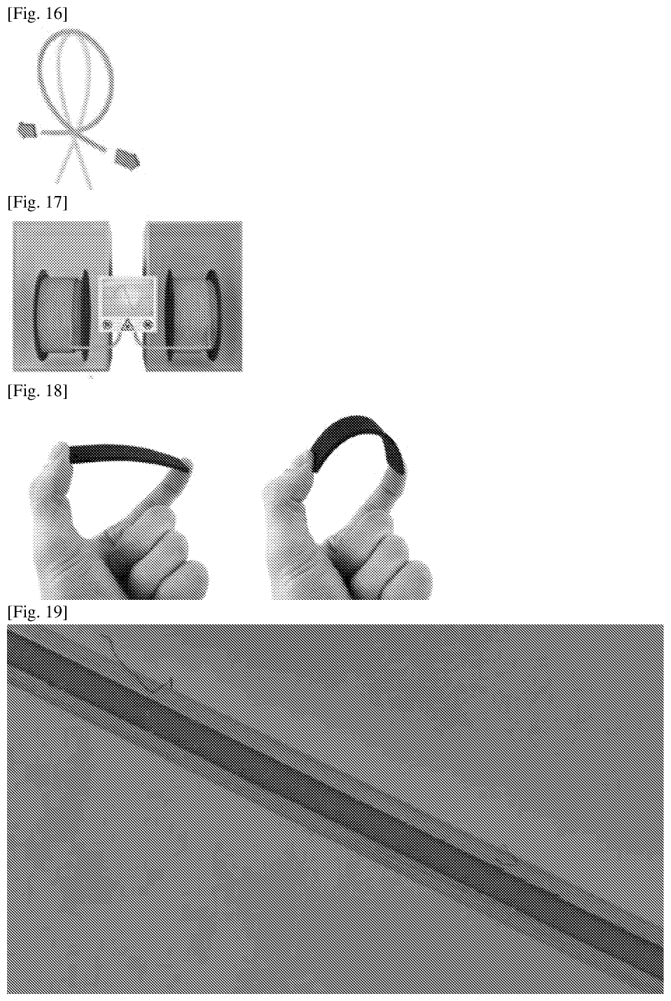

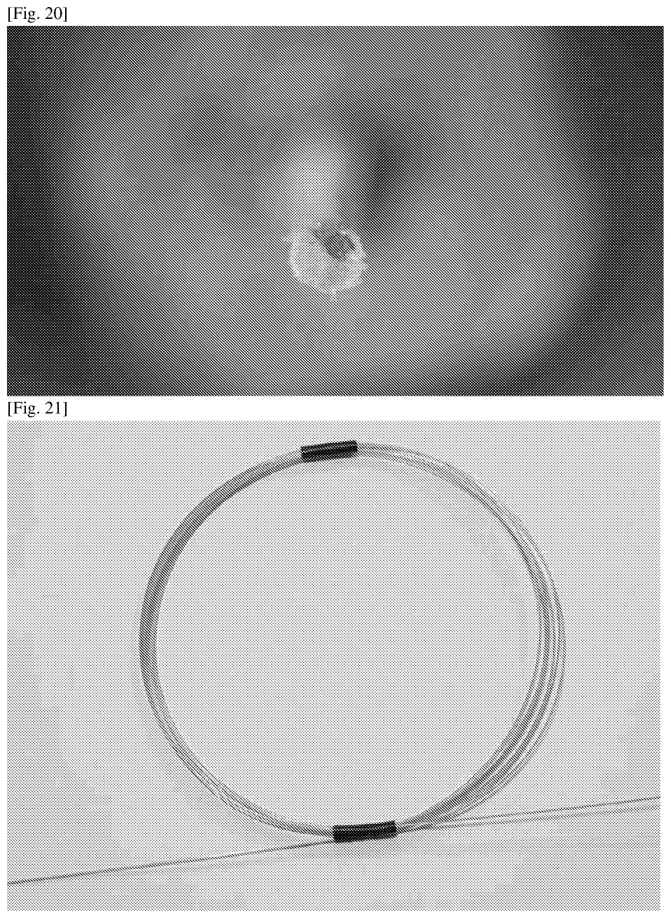

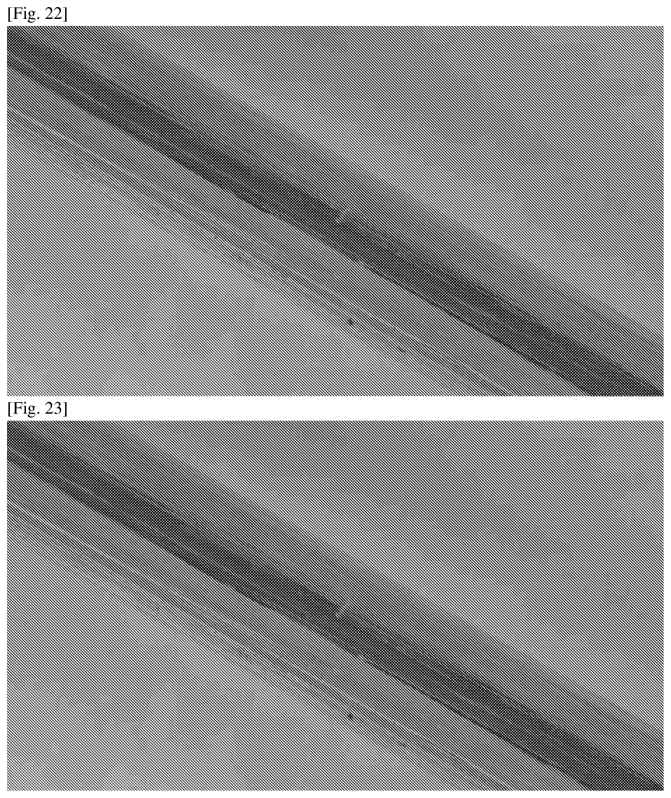

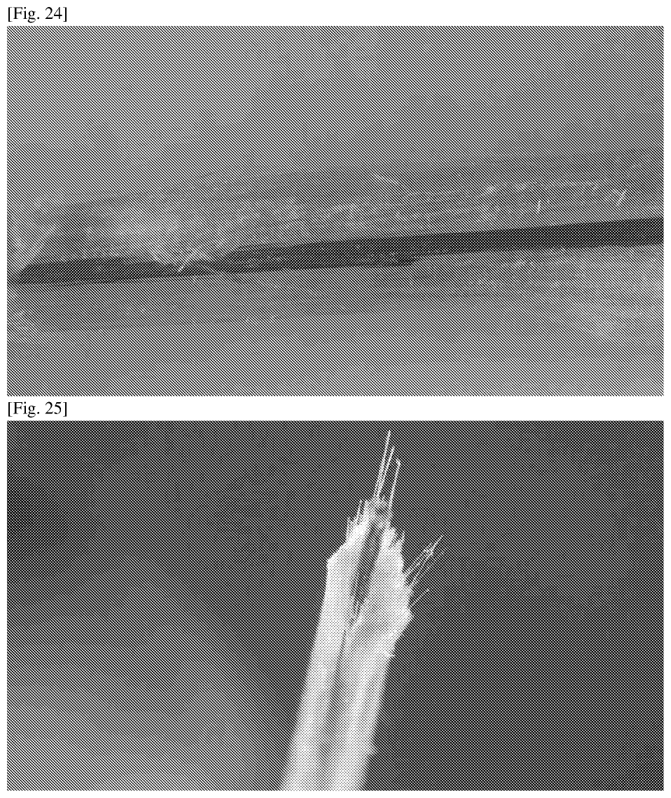

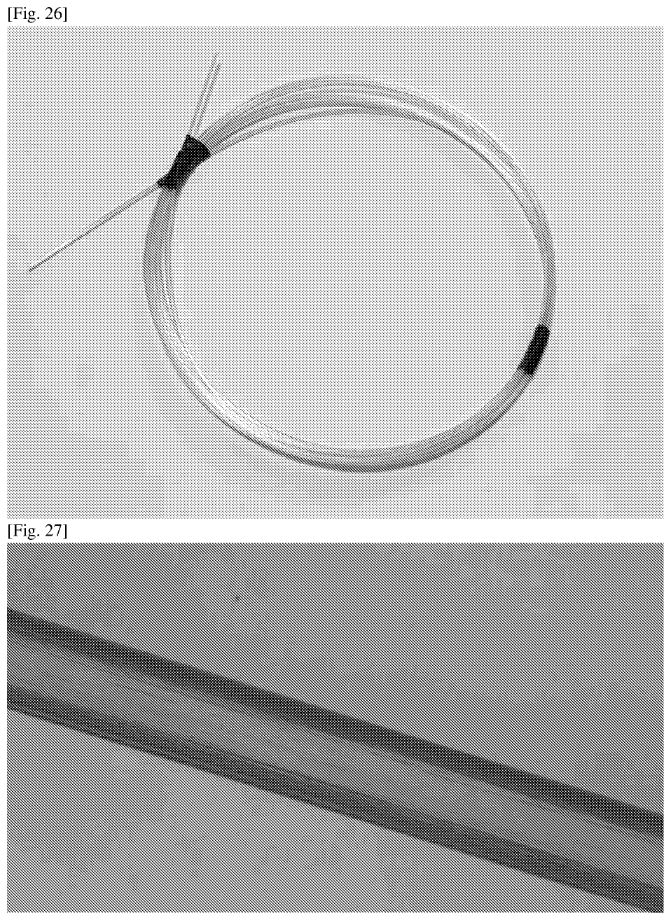

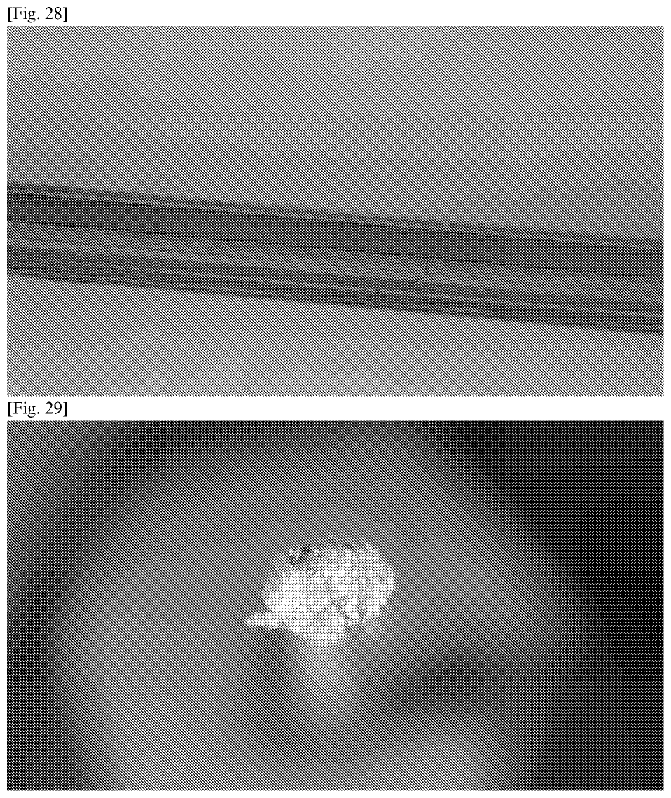

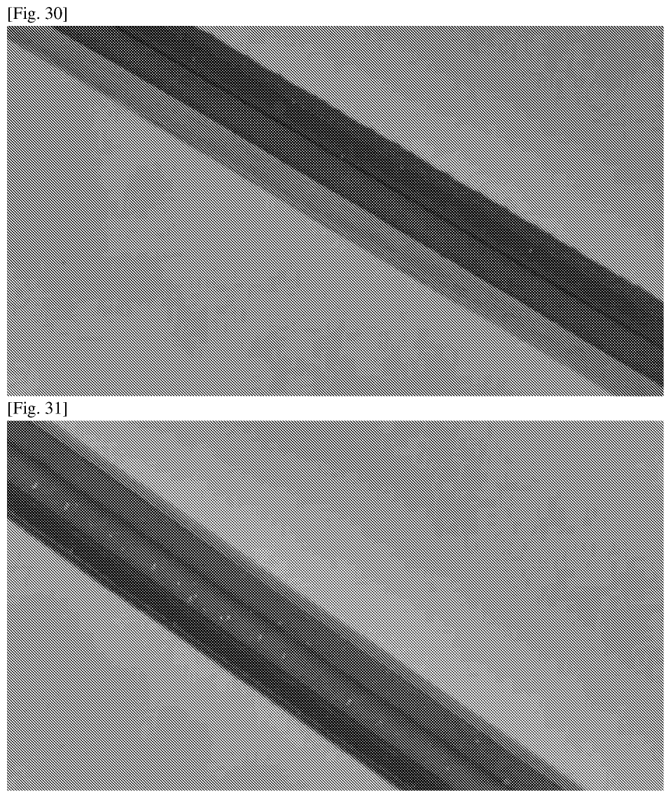

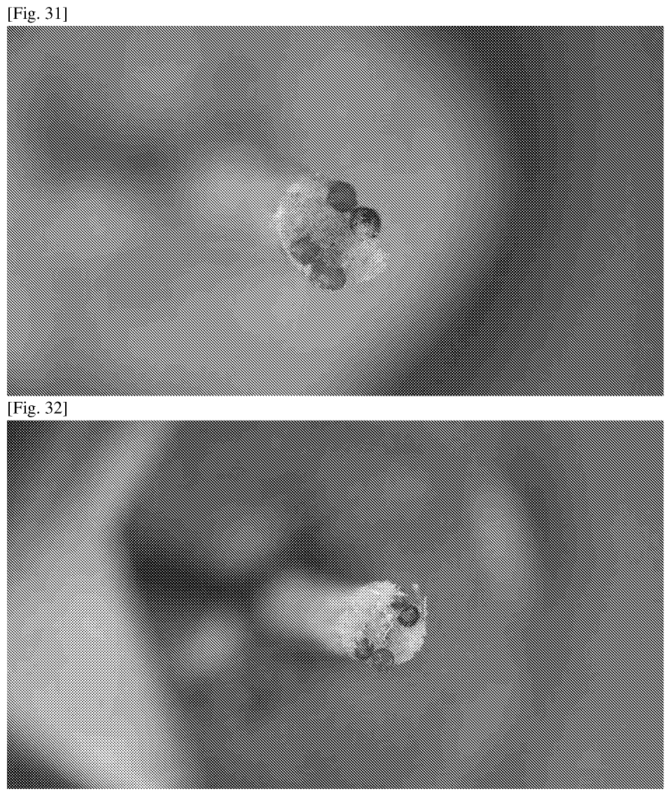

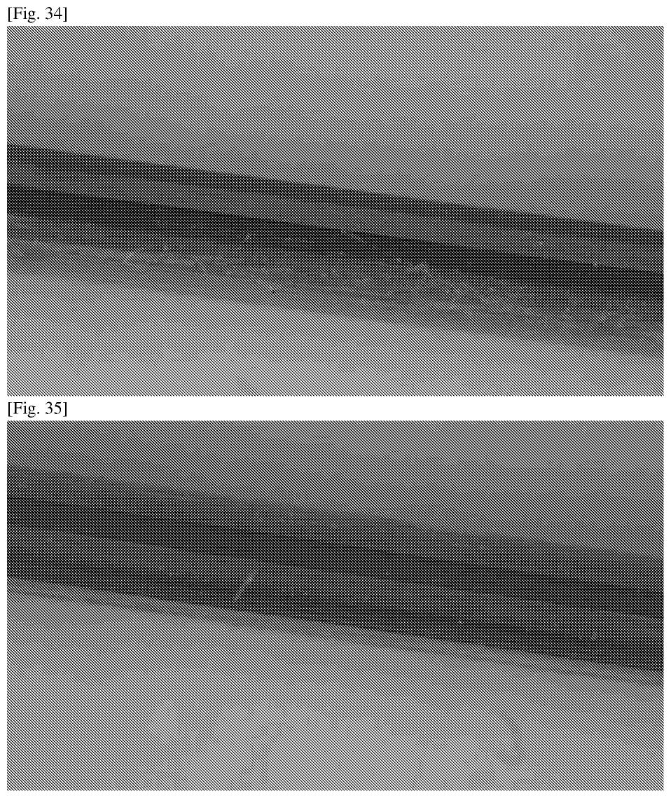

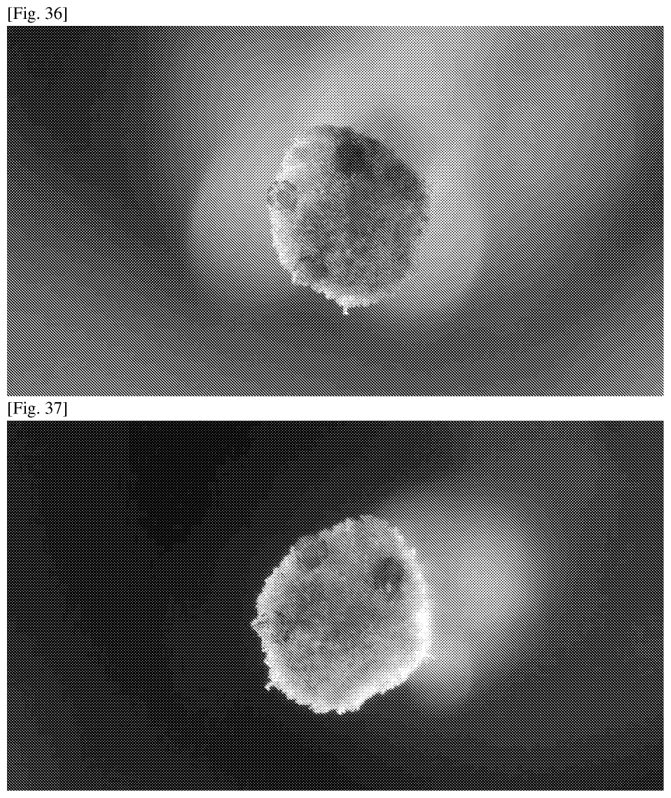

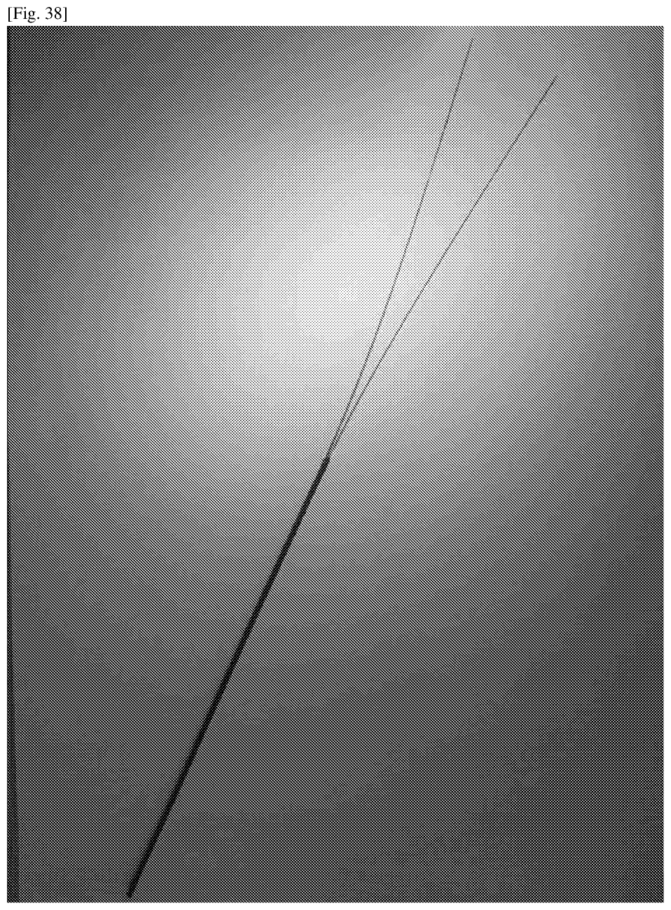

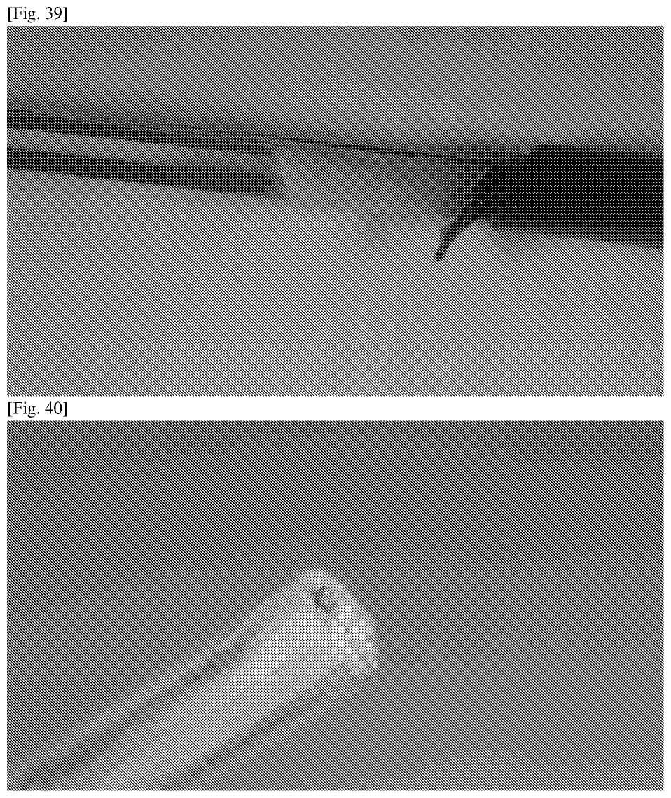

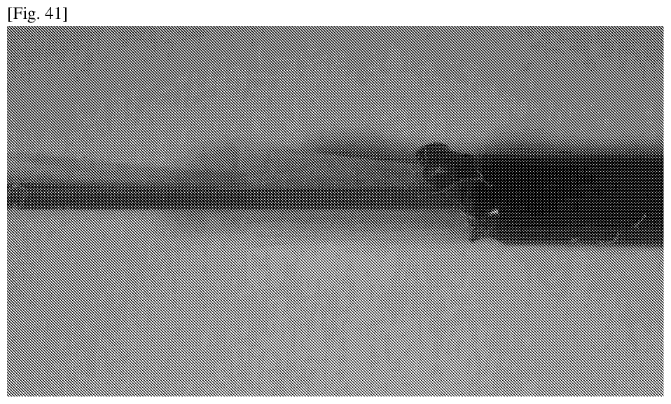

### INDUSTRIAL APPLICABILITY

manufacturing cables that used optical composite units can be used in a variety of applications:

Micro optical cable for air blowing: Due to the low diameter and high elasticity of cables produced by composite units, one of the best options available is the production of micro cables using the proposed innovation.

Production of Duct Optical Cables: Due to the lower diameter and high tensile strength (which is required for duct cables at the time of installation) and the higher capacity of fixed diameter cables, duct cables can be stronger and with much capacity.

Production of direct burial optical cables: Due to the ability to withstand very high cross-sectional pressure and also low cable diameter, it is possible to produce much more durable cables with much lower installation price using the proposed innovation.

Drop optical cable production: Due to the very low diameter and high tensile strength and impact resistance of the cable produced using the proposed innovation will have much greater reliability and much longer service life.

Production of optical cables for indoor installation (Indoor cable): Due to the very low diameter and also the very high elasticity of the cable produced using the proposed innovation, the efficiency of the cable for installation in confined spaces is greatly increased.

Production of tactical optical cables with special application (tactical optical cable): Due to the very small diameter (volume) of the cable, extremely high physical parameters of the cable (such as high tensile strength support, high pressure tolerance support, very high impact resistance, high and low temperature range tolerance support), very low cable weight and very easy to transport, very high elastic modulus that prevents the cable from twisting and knotting in any situation, as well as the homogeneity of the cable due to the release of stress along the cable, making it possible to use the proposed innovation to produce a variety of tactical cables for special use or specific applications with full support for the required technical specifications.

1. Contrary to the usual method used in the production of Tight-Buffer cables, instead of covering the optical fibers one by one with plastics such as PVC, Polyamide, Polyurethane, Polyethylene and contrary to the usual method used in the production of Ribbon cables that use just some resin polymer to put fiber optic core together, In this invention 1 to 8 optical fibers (which can be expanded to a higher number) With colored acrylic or colored silicone coating or any other protective coating (or without protective coating) Regularly located on the cross section or outer surface of a ROD (or any other geometric or non-geometric shape) that made of composite of fiber reinforced polymers FRP (Fiber Reinforcement Plastic or polymer) and produce in pultrusion process. FRP ROD diameter can be 300 microns (or less) to 1200 microns (or more). Optical fibers are placed at the FRP cross-section in such a way that their position can be constant or variable in length and change their position regularly or irregularly at certain distances. In this case, all or part of the cross section of the optical fiber placed in the cross section of FRP ROD. Each of these FRP rods which the optical fibers are embedded in is called an optical composite unit (OCU). Each optical composite unit is coated with a layer by thickness of 50 microns (or less) to 300 microns (or more) of plastic (PVC, Polyamide, Polyurethane, Polyethylene, or any plastic) and in some cases the optical composite unit can be uncoated. One to any number of optical composite units can be placed next to each other with any arrangement and form an optical cable with different capacities, dimensions and cross-sectional shape of each optical composite unit can be designed and created in any geometric or non-geometric shape and in any dimensions so that there is at least empty space between the optical composite units in cable. The location and the number of the optical Fiber in the optical composite unit can be changed according to the application of the optical cable and special mechanical resistance parameters. When it is necessary to make the optical fiber available for connection (fusion) operation, by separating the reinforce fiber, the FRP structure is broken and the optical fibers are made available for strip and fusion.
